(19) United States
(12) Patent Application Publication
(10) Pub. No.: US 2006/0238365 A1
(43) Pub. Date: Oct. 26, 2006

(54) Short-range wireless power transmission and reception

(76) Inventors: Elio Vecchione, Toulouse (FR); Conor Keegan, Toulouse (FR)

Correspondence Address: LAW OFFICES OF MICHAEL DRYJA, 704 228TH AVENUE NE, PMB 694, SAMMAMISH, WA, 98074, US

(21) Appl. No.: 11/224,451

(22) Filed: Sep. 12, 2005

Related U.S. Application Data
(60) Provisional application No. 60/594,617, filed on Apr. 24, 2005.

(51) Int. Cl. G08B 21/00

(52) U.S. Cl. 340/657; 320/138

(57) ABSTRACT

A short-range wireless power transmission and reception system and method are provided. Power is transmitted from the electrical utility mains power supply to electrically powered appliances via electromagnetic radiation. The appliances are capable of receiving the transmitted power, converting it into electricity and storing it for subsequent use, as well as using it directly to power the appliances.

### RELATED APPLICATIONS

The present patent application claims priority to and the benefit of the provisional patent application entitled “Short-range wireless power transmission and reception,” filed on Apr. 24, 2005, and assigned Ser. No. 60/594,617.

### FIELD OF THE INVENTION

The present invention generally relates to a system for wirelessly transmitting electrical utility power to electrical and electronic appliances over short ranges, typically in a domestic and office environment. In particular, the electricity can be either stored in a battery for use by the appliance, or used directly to power the appliance, or both.

### BACKGROUND OF THE INVENTION

With the advent of wireless communication protocols such as Wi-Fi or Bluetooth, consumers are realizing that life without physical cables is easier, more flexible and often less costly. The major stumbling block to removing cables entirely is now the electrical power cables connecting electrical and electronic appliances to the commercial electrical power utility.

Photovoltaic solar cells are sometimes used to complement or avoid the electrical utility power grid and the associated cables. However, they rarely provide enough power to be considered as a serious alternative to the grid, and in any case suffer from the restriction of needing sunlight or a suitable light source to operate.

Portable electronic and electrical devices, ranging from cell phones to hand held drilling machines, appear to avoid cables. However, these devices contain a battery whose capacity determines the autonomy of the device, and which needs to be periodically replaced or recharged via a battery charger and cables connected to the electrical utility. Additionally, portable appliances are often required to be used in a “fixed” mode in a domestic and office environment, and a connection to the electrical utility is necessary.

As a result, wireless power transmission is desirable. Wireless power transmission was originally proposed to complement or avoid long distance electrical distribution based mainly on copper cables. It was later proposed to use microwave beams to provide power to aircraft flying within view of a microwave transmitter, and this system was successfully prototyped. The main technology developed was the rectifying antenna, or rectenna, which can receive electromagnetic radiation and convert it efficiently to DC electricity.

These ideas were taken up again with the advent of satellites, whereby a satellite could either be powered by microwave beams from earth; used to collect solar power and transmit it to earth; or simply be used as a high visibility relay for electricity produced on earth. There are, however, technical difficulties associated with the idea: because of the large distances involved, free space loss is considerable; furthermore, the Earth's atmosphere absorbs and scatters certain electromagnetic frequencies, reducing the possible frequencies that can be used. There is a resurgence of interest in this topic, but the focus is still on high power, long range systems, and is not directly relevant to short range, domestic and office type applications.

A number of medium range (from 10 to 1000 meter) wireless power transmission-related patents have been issued. Remote power transmission and charging systems for electrically powered vehicles are described in U.S. Pat. Nos. 5,982,139; 6,114,834; and, 6,792,259, which use electrical power stations distributed in urban or country locations to beam power to vehicles, typically in the range of 200 to 500 meters. A further US patent application, 2004/0142733, relates to a remote power transmission system for recharging electronic equipment, which can be used in a domestic and office environment. However, both the patents and the patent application are based on the technology used for vehicle power transmission, which includes a directional transmission of the power beam to specific receivers, guided by a control signal from the receivers. As a result, the system is unnecessarily complex.

US patent application 2002/0190689 describes a power supply for portable electronic devices, which receives ambient radio frequency radiation (typically in an urban environment) and converts it to DC electricity that is stored in a battery for use by the portable device. In this case, there are no dedicated transmitters and the receiver “parasites” existing RF transmissions.

U.S. Pat. No. 5,300,875 describes different concepts for remotely powering RF ID transceivers, including RF transmission. These transceivers are powered for the duration of the communication with an interrogating system and are not considered as electrical appliances.

Lastly, U.S. Pat. Nos. 6,798,716; 6,342,776; and, 5,889,383 all deal with the transmission of power using ultrasound, which is not an electromagnetic phenomenon.

### SUMMARY OF THE INVENTION

The present invention relates to a system for wirelessly transmitting electrical utility power to electrical and electronic appliances over short ranges, typically in a domestic and office environment.

In one embodiment, a power transmission unit (PTU) is connected to the electrical utility, typically in a domestic and office environment, and uses the electricity to generate a beam of electromagnetic radiation. This beam can take the form of visible light, microwave radiation, near infrared radiation or any appropriate frequency or frequencies, depending on the technology chosen. The beam can be focused and shaped using a focusing mechanism: for example, a parabola shape may be chosen to focus light waves at a certain distance from the PTU.

A power reception unit (PRU) receives power from one or several PTU's, and converts the total power received to electricity, which is used to trickle charge a storage unit such as a battery or transferred directly to the appliance for use, or both. If transferred to the storage unit, the output of the storage unit can power the appliance. Similarly to the focusing of the transmitted power, it is possible to concentrate the received power for conversion, using receiving arrays, antennas, reflectors or similar means.

The PRU technology can be a rectenna, a photovoltaic cell, nanotechnology antennas or any other technology capable of converting electromagnetic radiation to electricity, or any combination of the above. It is possible to combine the use of the system with existing technologies and ambient radiation. For example, PDA's or calculators using solar cells may be powered in parallel with solar power or independently using a PTU transmitting in the visible frequency range.

A number of auxiliary functions can be included, such as cutting off the transmitted power if all the power is reflected back to the transmitter, and indicating the total power received by the PRU.

The units in the power reception chain may be integrated in or separated from the appliance to be powered. “Appliance” is defined here as any device that is powered by electricity, such as a cell phone, a computer or a hand held power drill. Additionally, the elements in the transmission chain may be integrated in or separated from the power supply outlets or electrical plugs.

The system of at least some embodiments of the invention is intentionally limited to short ranges to avoid the need for complicated pointing or tracking mechanisms, and not to exceed allowed radiation limits. However, it is possible to construct power “relay units”, consisting of PRU's powering PTU's, whose function is to make the transmitted power available at further distances than would normally be possible.

Still other aspects and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an exemplary embodiment of PTU's, mounted on wall and ceiling in home or office environment.

FIG. 2 is a diagram of an exemplary embodiment of PTU's with integrated commercial power supply outlets, mounted on a wall.

FIG. 3 is a diagram of an exemplary embodiment of PTU's in the form of a power supply plug, and plugged into the commercial power supply outlet in a wall. The commercial power supply outlet may include an on/off switch, which is not depicted in FIG. 3.

FIG. 4 is a diagram of an exemplary embodiment of PTU's in power plugs with transmission reflector antennas.

FIG. 5 is a diagram of an exemplary embodiment of devices with integrated or attached PRU's and external or integrated antennas.

FIG. 6 is a diagram of an exemplary embodiment of devices with PRU's receiving energy from a PTU and ambient EM radiation.

FIG. 7 is a diagram of an exemplary embodiment of a laptop PC with integrated flat antenna and PRU.

FIG. 8 is a diagram of an exemplary embodiment of a relay PTU providing power to appliances out of line of sight of main PTU.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

One embodiment of the present invention is a system for wirelessly transmitting electrical utility power to electrical and electronic appliances over short ranges. “Appliances” are defined here as any device that is powered by electricity, such as a cell phone, a computer or a hand held power drill. Two parts of this embodiment of invention include a power transmission chain, connected to the electrical power utility; and a power reception chain, connected to the appliance to be powered.

A power transmission unit (PTU) is connected to the electrical utility power distribution system, normally via an on/off switch and typically in a domestic and office environment. The PTU uses the electricity to generate a beam of electromagnetic (EM) radiation. Electrical utility power comes in two main flavors worldwide, those based on the US standard of 120 V, 60 Hz AC and the others based on the European standard of 230V, 50 Hz AC, with voltage variations of up to approximately +/−10% from these standards being found in the local standards. Mono or multi-phase outlets are possible. This invention applies to all of these standards.

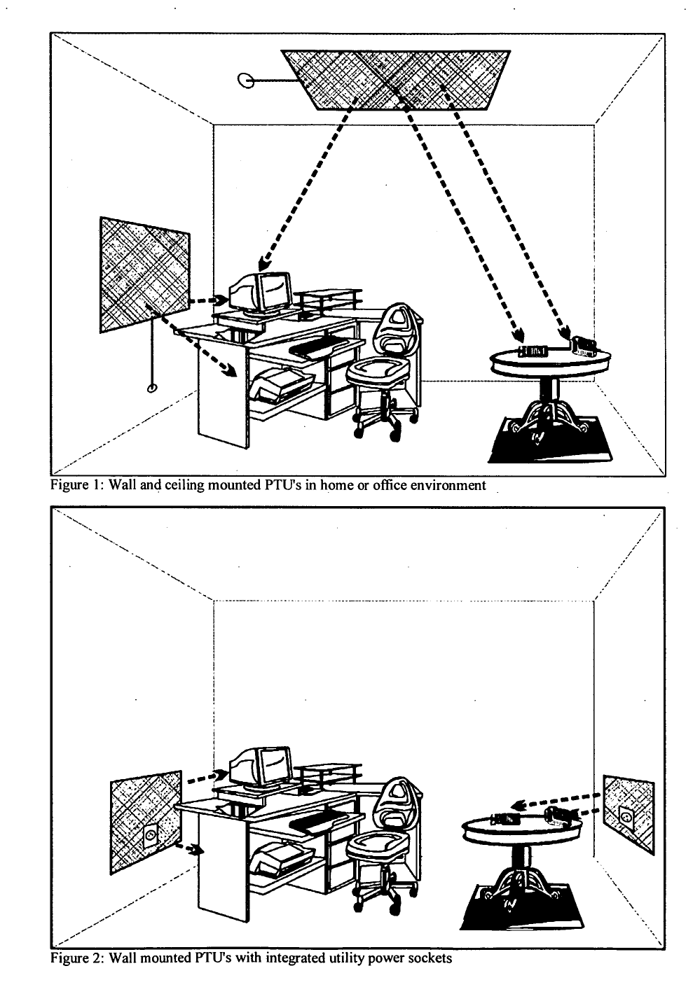

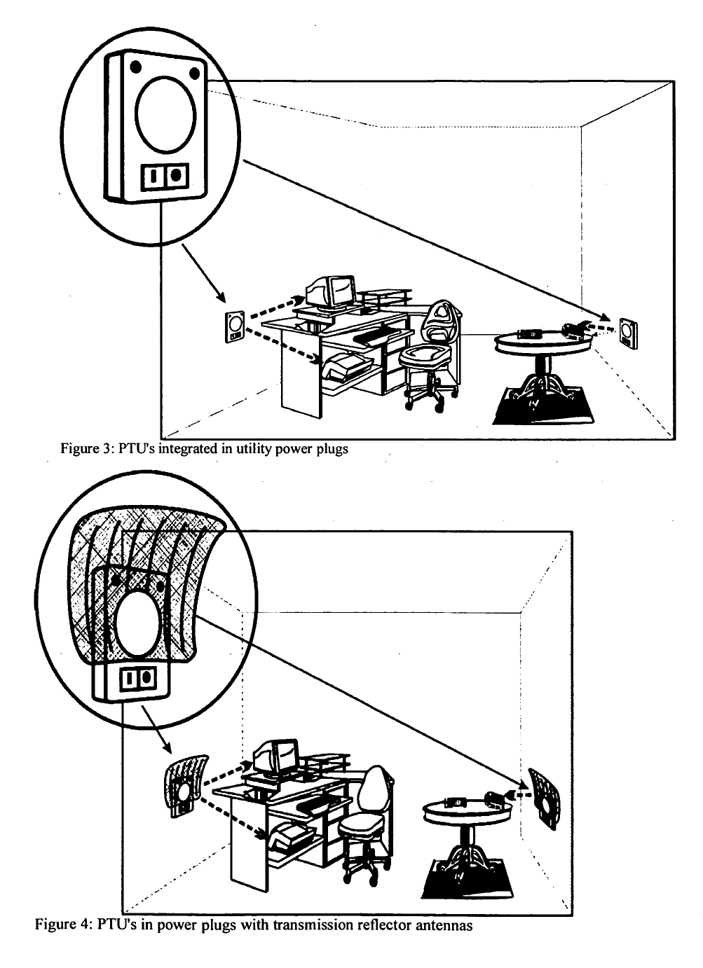

FIG. 1 shows PTU's connected to the utility power as dedicated units, according to an embodiment of the invention. They can be integrated in structures such as a wall or ceiling in a house or mounted on such structures, providing an electrical “hot spot” for nearby appliances. Depending on the operating frequencies chosen, the PTU's can be hidden behind a cover that is transparent to the EM radiation. Alternative embodiments in FIGS. 2 and 3 show the PTU integrated with a power outlet. In particular, FIG. 2 shows a PTU combined with a conventional power outlet, allowing simultaneous cable and wireless power transmission, while FIG. 3 shows a PTU in the form of a plug that is plugged into a conventional power outlet.

One function of the PTU is to use the utility electricity to generate and transmit a beam of electromagnetic energy. Any EM generation devices are possible, including dipole antennas, magnetrons, klystrons or traveling wave tubes for RF generation, to LED's or lasers for light generation. The output power of the device may be fixed or selectable. The entire electromagnetic spectrum can potentially be used for power transmission and is encompassed by embodiments of the invention, although in general the higher frequencies are preferred to reduce system size.

The PTU may generate a single frequency or multiple frequencies simultaneously or sequentially, using one or several means. This is achieved in particular to reduce the power flux density transmitted in a given frequency band over a given time, which may be limited due to health or interference considerations. For example, half of the energy generated may be transmitted by LED's in the blue part of the visible spectrum and one quarter in near infra-red, and the remaining quarter by a magnetron in S-band. Certain frequencies are more or less susceptible to shadowing or blocking, and frequency diversity is also desirable to allow reception under different circumstances. PTU's are not necessarily dedicated to a single appliance and can transmit power to any appliance falling within their beam patterns.

Focusing mechanisms such as reflectors, waveguides, sub-reflectors, antennas, arrays and lenses are common in EM transmission technologies and can all be used to focus and shape the generated EM radiation beam(s). Such means are referred to here in general as “antennas”. In FIG. 4, a parabolic reflector is used to produce a slightly divergent EM beam from the PTU, according to an embodiment of the invention. These antennas are optimized according to the nominal wavelength to be used, but antennas for several different frequencies can be integrated in the same physical support. For example, 2 GHz RF radiation has a wavelength of 15 centimeters (cms), and a corresponding antenna is normally at least this size. Visible light has a wavelength of the order of micrometers, and optical reflectors with dimensions of 1 or 2 cms can be integrated on a 2 GHz antenna with only a slight degradation of the RF antenna. Separated antennas for the different transmitted frequencies are covered by this patent, but the preferred embodiment is to combine them all in a single structure.

Antennas are a way to concentrate transmitted energy, but in particular they are used to trade off the level of transmitted power against the area over which the power can be received. If a beam is highly focused, it may only be received over a very limited area, which is not desirable if we want to operate an appliance anywhere in a living room. On the other hand, if the beam is spread over too wide an area, little power is available at any point. For this reason, it is possible to modify the orientation, beam width and shape of the transmitted beam by manually or remotely adjusting the antenna, or the distance between the light source and the reflector, so as to vary the beam width and pattern. In FIG. 4 it is assumed that the reflector material is flexible and allows manual shaping.

An optional transmission cut-off mechanism can be used in case too much power is reflected back to the transmitter. If most of the transmitted energy is reflected back to the PTU/antenna, this normally means that they are simply blocked by an object, and for economic, health and transmitter overload reasons, it is better to turn off the transmitter until the reflected level drops. A receiver integrated in either the PTU or the antenna or both can receive the power and compare it with the transmitted level. If the received level is above a user-selectable level, then the transmission can be cut off automatically.

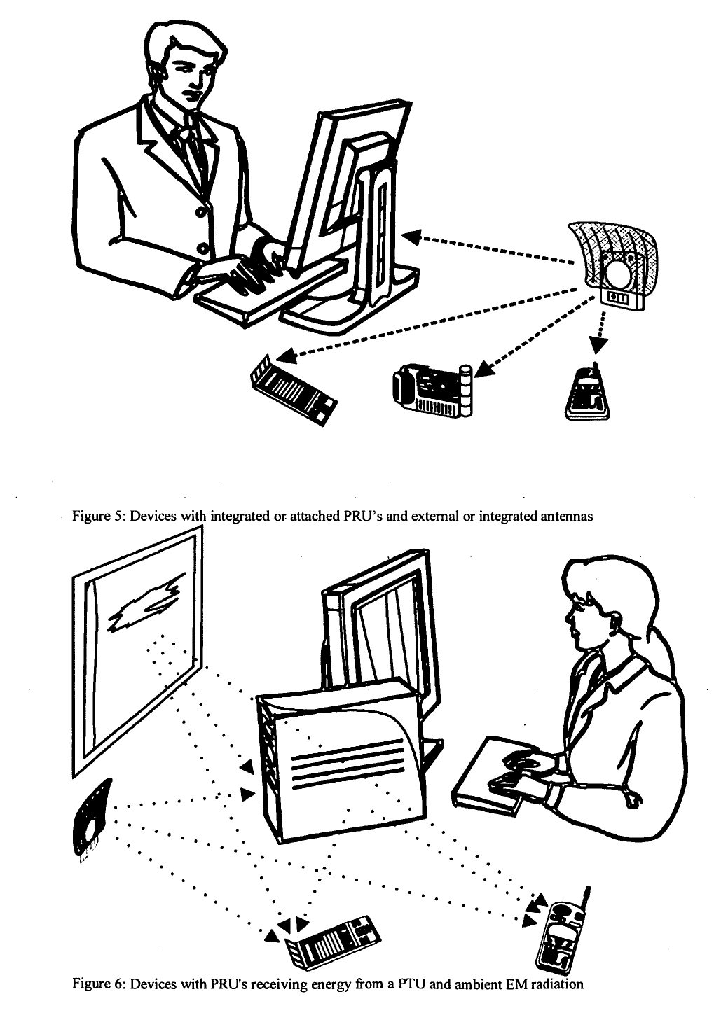

In a similar way to the transmission antenna, a collector/focusing mechanism can be included to concentrate the radiated power available in a given area for conversion to electricity (such means are also referred to here in general as “antennas”). Such antennas are in common use for EM radiation and any suitable means can be used such as receiving arrays, antennas, and reflectors. In FIG. 5, a curved reflector on the PC screen support is used to focus EM radiation onto a receiver, according to an embodiment of the invention, in at least substantially the same way as for transmission, and a flat reflector is used for a PDA. A receiving antenna can be dedicated to a single frequency or used to receive several frequencies: the preferred embodiment is to receive all frequencies with a single mechanism. As for transmission, an antenna can be adjusted manually or remotely in terms of orientation, beam width, pattern and distance between reflector and receiver.

In the same way that a PTU can transmit power to several appliances within its beam width, a receiving antenna can receive the total power over its collecting surface, which may come from one or several PTU's or from ambient radiation such as radiation from other appliances, daylight or artificial lighting. Providing the receiving antenna and receiver have been designed to receive the corresponding frequencies, all of this radiation can be summed and is potentially available for conversion to electricity. In FIG. 6, radiation is received from the PTU, ambient EM radiation from a nearby PC and ambient daylight from a window, according to an embodiment of the invention.

A power reception unit (PRU) receives power from one or several PTU's or other EM sources, either directly or via a receiving antenna. A PRU can receive and convert single or multiple frequencies simultaneously. The total power received is converted to electricity, which is used to trickle charge an electrical storage unit such as a battery or ultra capacitor, or transferred directly to the appliance for use, or both. If transferred to the storage unit, the output of the storage unit can power the appliance as required.

It should be noted that an appliance may use multiple PRU's to power individual parts or even components of the appliance directly, thereby avoiding resistive losses and heating associated with the transmission of energy from a central power supply in the appliance. As an extreme example, a computer screen matrix could incorporate PRU's to power individual pixels or groups of pixels.

In general, the PRU can be made with any technology that allows the conversion of electromagnetic radiation to electricity, such as rectennas, nanotechnology antennas, photovoltaic cells, or any combination of such technologies. In case of multiple technologies, each technology may be optimized for use with the same or different frequencies. They can be physically superposed in the same structure; for example, a layer of rectennas can be overlaid over a solar cell layer to receive the same or different frequencies. All means to improve the efficiency of such receivers can be used, such as multiple layers, reflective or absorptive materials, lenses, or frequency shifters. The examples of energy receptors described herein are intended to be exemplary and are not intended to limit the scope of the invention unless otherwise specifically indicated.

A power reception monitor can be connected to either or both of the receiving antennas or PRU's, capable of indicating the level of total received power and indicating it, either as a direct display or by transferring it in electronic form to the appliance to be powered, or both. It is possible to trigger an alarm signal if the received level drops below a selectable level.

Each of the units in the power reception chain above (antenna, PRU, power storage unit, power reception monitor, power distribution unit) may be integrated inside the housing of the appliance to be powered, attached externally to the housing and use an interface connector as necessary, or separated from the appliance and connected by cables. For example, FIG. 5 shows:

a PDA with an external flat antenna that can be folded back, connected to a PRU inside the PDA;

a digital camera with an external PRU but no antenna, connected to the camera battery charger via the DC power input; and,

a cell phone, with planar antenna and PRU integrated inside the cell phone.

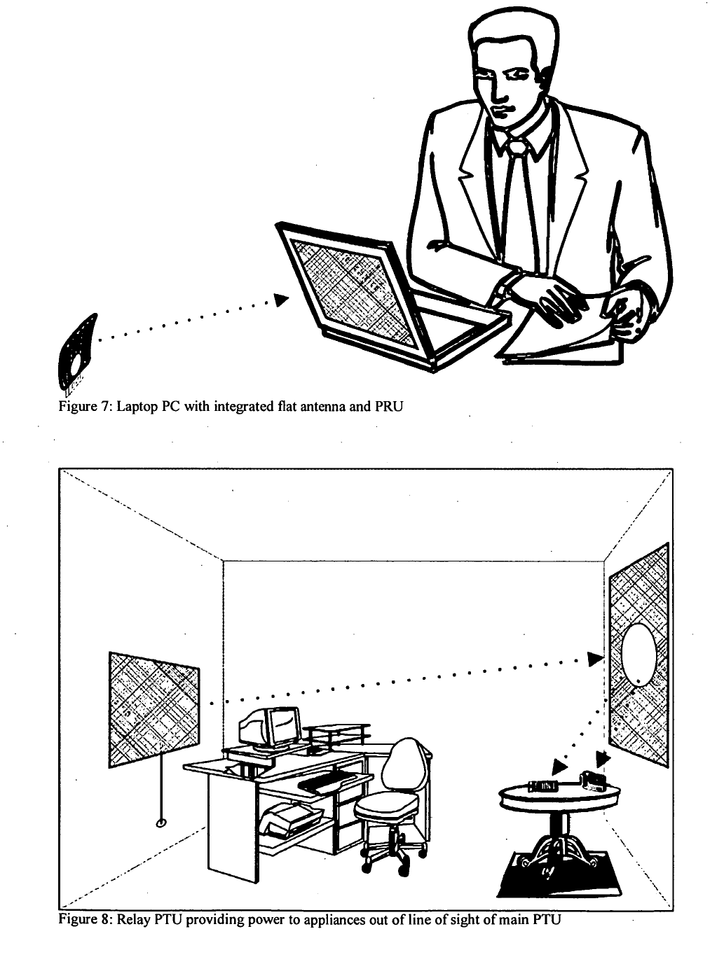

FIG. 7 shows a laptop PC that has an antenna and PRU integrated on the upper surface of the laptop lid, on the reverse side of the screen, according to an embodiment of the invention.

The system is in at least some embodiments intentionally limited to short ranges to avoid the need for complicated pointing or tracking mechanisms, and not to exceed allowed radiation limits. However, it is possible to construct power “relay units” as shown in FIG. 8, which can allow the transmission of power at further distances than would normally be possible. These relay units consist of a PRU with an optional receiving antenna, receiving power from a normal PTU. Within the relay unit, the power distribution unit transfers electricity to a PTU, which then converts this electricity to an EM beam for use by further appliances. FIG. 8 shows a passive relay unit, according to an embodiment of the invention, where the relay unit is not connected to the electrical utility, but relay units can also be active whereby they are connected to the electrical utility and transmit power based on the electricity utility as well as power received from other PTU's.

The present invention has been described above in relation to a particular embodiment or embodiments. However, the scope of the present invention is not limited to the scope described in relation to the above-described embodiments. It can thus be appreciated by those skilled in the art that various alterations or modifications can be made to the above-described embodiments. It is further readily apparent to those of ordinary skill within the art that the scope of claims encompasses aspects added and/or alterations or modifications made to the present invention as embodiments of which have been specifically described above. Therefore, although embodiments of the present invention have been described in detail, it should be understood that various changes, substitutions, and alternations can be made therein without departing from spirit and scope of the invention as defined by the following claims.

What is claimed is:

1. A short-range wireless power system for an appliance, comprising:
a power transmission unit connected to a commercial electrical power supply and capable of transmitting energy in a form of a wireless electromagnetic (EM) power beam when activated;
a power reception unit capable of receiving the wireless EM power beam when activated, and converting the wireless EM power beam to electricity;
an electrical power storage unit capable of storing the electricity for subsequent use; and,
a power distribution unit capable of receiving the electricity from at least one of the power reception unit and the electrical power storage unit, and transferring the electricity for use by the appliance.

2. The system of claim 1, wherein the system is capable of operating on one of a single frequency and multiple frequencies.

3. The system of claim 1, further comprising a focusing mechanism capable of controlling a width of the wireless EM power beam and a pattern of the wireless EM power beam,
wherein orientation and focusing of the wireless EM power beam is at least one of: fixed, manually variable, and variably responsive to an external control signal.

4. The system of claim 1, further comprising a reflected power reception monitor for the power transmission unit, capable of detecting an amount of power transmitted in the wireless EM power beam and reflected back, and automatically cutting off transmission where a received level of power is sufficiently high.

5. The system of claim 1, further comprising a collector/focusing mechanism connected to the power reception unit, the collector/focusing mechanism and the power reception unit together capable of one of: receiving and converting the wireless EM power beam over a given receiving surface; and, receiving, concentrating, and converting the wireless EM power beam over the given receiving surface,
wherein orientation of the collector/focusing mechanism is at least one of: fixed, manually variable, variably responsive to a defined algorithm, and variably responsive to an external control signal.

6. The system of claim 5, wherein the collector/focusing mechanism is further capable of collecting and focusing power from ambient electromagnetic radiation.

7. The system of claim 1, further comprising a power reception monitor connected to the power reception unit and capable of measuring and indicating a level of total received power,
wherein the power reception monitor is capable of indicating the level of total received power by at least one of: directly displaying the level, and by transferring the level in electronic form to the appliance.

8. The system of claim 1, wherein the power transmission unit is integrated in a commercial power supply outlet.

9. The system of claim 1, further comprising a commercial power plug encompassing the PTU, and which is capable of being plugged into a commercial power supply outlet.

10. The system of claim 1, wherein at least one of the power reception unit, the electrical power storage unit, and the power distribution unit are integrated in the appliance.

11. The system of claim 1, wherein the power reception unit is further capable of receiving power from ambient electromagnetic radiation.

12. The system of claim 11, wherein the ambient electromagnetic radiation is within one of: a same frequency range as the wireless EM power beam; and, a different frequency range as the wireless EM power beam.

13. The system of claim 11, further comprising at least one of:
one or more additional power transmission units; and,
one or more additional power reception units.

14. A power retransmission unit comprising:
a power reception unit capable of receiving a first wireless electromagnetic (EM) power beam when activated, and converting the first wireless EM power beam to electricity;
an electrical power storage unit capable of storing the electricity;
a power distribution unit capable of receiving the electricity from at least one of the power reception unit and the electrically power reception unit; and,
a power transmission unit connected to the power distribution unit and capable of transmitting the electricity in a form of a second wireless EM power beam when activated.

15. The power retransmission unit of claim 14, further comprising a collector/focusing mechanism connected to the power reception unit, the collector/focusing mechanism and the power reception unit together capable of one of: receiving and converting the first wireless EM power beam over a given receiving surface; and, receiving, concentrating, and converting the first wireless EM power beam over the given receiving surface.

16. The power retransmission unit of claim 14, further comprising a reflected power reception monitor for the power transmission unit, capable of detecting an amount of power transmitted in the second wireless EM power beam and reflected back, and automatically cutting off transmission where a received level of power is sufficiently high.

17. The power retransmission unit of claim 14, further comprising a power reception monitor connected to the power reception unit and capable of measuring and indicating a level of total received power.

18. The power retransmission unit of claim 14, further comprising a focusing mechanism capable of controlling a width of the second wireless EM power beam and a pattern of the second wireless EM power beam.
